(19) United States
(12) Patent Application Publication
(10) Pub. No.: US 2015/0259126 A1
(43) Pub. Date: Sep. 17, 2015

(54) INSULATED APPARATUS FOR SHIPPING AND STORAGE AND PROCESS FOR FABRICATING THEREOF

(71) Applicants: James MCGOFF, Silver Spring, MD (US); Brian POWERS, Adelphi, MD (US); Charles VINCENT, St Bruno de Montarville (CA)

(72) Inventors: James MCGOFF, Silver Spring, MD (US); Brian POWERS, Adelphi, MD (US); Charles VINCENT, St Bruno de Montarville (CA)

(21) Appl. No.: 14/594,320

(22) Filed: Jan. 12, 2015

Related U.S. Application Data
(60) Provisional application No. 61/926,157, filed on Jan. 10, 2014.

(51) Int. Cl. B65D 81/38; B23P 19/00

(52) U.S. Cl. CPC B65D 81/3825; B65D 81/3813; B23P 19/00

(57) ABSTRACT

An insulated apparatus includes an outer container which defines an inner chamber. An insulated container is disposed in the inner chamber. The insulated container defines a sub-chamber of the inner chamber. An inner lining covers the inner surface of the insulated container and further defines a payload chamber, in which contents may be stored in a temperature controlled environment. A process for forming a storage apparatus includes providing an outer container, forming a base panel, a lid panel, and wall panels from a first material according to an interior dimension of the outer container, and assembling the base panel and walls panels to form an insulated container within the outer container. Where required, the process further includes forming a first panel and a second panel from a second material according to an interior dimension of the insulated container. The panels are then adhered to the interior of the insulated container.

### CROSS REFERENCE TO RELATED APPLICATIONS

The present application claims priority from U.S. provisional patent application No. 61/926,157, filed Jan. 10, 2014 and entitled “INSULATED APPARATUS FOR SHIPPING AND STORAGE AND PROCESS FOR FABRICATING THEREOF”, the disclosure of which is hereby incorporated by reference in its entirety.

### FIELD

The present subject-matter relates to an insulated apparatus usable for shipping and/or storage and process for fabricating the apparatus, and more particularly to an apparatus having an insulated container and an inner insulating lining covering an inner surface of the inner chamber.

### INTRODUCTION

Many industries require the storage and transportation of material in a temperature-controlled environment. These industries include blood services, research laboratories, biopharmaceutical industry, medical industry, third party logistics and food services. Typically, such temperature-controlled storage and transportation is carried out using a container formed of a single type of insulating material.

For example, one commonly available container is formed entirely of polystyrene. Contents are placed within a chamber of the container. Such a type of container is effective for most purposes requiring temperature-controlled storage and transportation, but may be improperly adapted for the different requirements that may be presented within the different industries. Furthermore, requirements in some industries may exceed the temperature-control characteristics of commonly available containers.

### SUMMARY

It would thus be highly desirable to be provided with an apparatus and process for fabricating thereof that would at least partially address the disadvantages of existing technologies.

According to one aspect, there is provided an insulated apparatus that includes an outer container defining an inner chamber, an insulated container disposed within the inner chamber, the insulated container comprising a base and upstanding walls extending from the base and an inner insulating lining covering an inner surface of the insulated container, the inner lining further defining a payload chamber.

According to another aspect, there is provided a process for forming a storage apparatus. The process includes inserting an inner insulated container formed of a first insulating material within an inner chamber defined by an outer container, the inner insulated container having outer dimensions substantially corresponding to interior dimensions of the outer container, the inner insulated container further defining an inner chamber; and inserting an inner lining formed of a second insulating material within the inner chamber defined by the inner insulated container, the inner lining defining a payload chamber.

### DRAWINGS

Reference will now be made to the accompanying drawings, showing by way of illustration non-limitative examples in which:

FIG. 1 illustrates an exploded view of an insulated container according to various exemplary embodiments;

FIG. 2 illustrates a perspective view of an inner lining according to various exemplary embodiments;

FIG. 3 illustrates a perspective view of an inner liming according to various exemplary embodiments;

FIG. 4 illustrates an exploded view of an inner lining according to various exemplary embodiments;

FIG. 5 illustrates an exploded view of an insulated apparatus according to various exemplary embodiments;

FIG. 6 illustrates a section view along the lines A-A of an insulated apparatus according to various exemplary embodiments;

FIG. 7 illustrates a section view along the lines A-A of an insulated apparatus according to various exemplary embodiments;

FIG. 8 illustrates a graph showing temperature of a payload chamber over time for various exemplary insulated apparatuses;

FIG. 9 illustrates a graph showing temperature of a payload chamber over time for various exemplary insulated apparatuses;

FIG. 10 illustrates a graph showing temperature of a payload chamber over time for various exemplary insulated apparatuses;

FIG. 11 illustrates a graph showing temperature of a payload chamber over time for various exemplary insulated apparatuses;

FIG. 12 illustrates a graph showing temperature of a payload chamber over time for various exemplary insulated apparatuses;

FIG. 13 illustrates a graph showing temperature of a payload chamber over time for various exemplary insulated apparatuses;

FIG. 14 illustrates a graph showing temperature of a payload chamber over time for various exemplary insulated apparatuses;

FIG. 15 illustrates a graph showing temperature of a payload chamber over time for various exemplary insulated apparatuses;

FIG. 16 illustrates a graph showing temperature of a payload chamber over time for various exemplary insulated apparatuses;

FIG. 17 illustrates a graph showing temperature of a payload chamber over time for various exemplary insulated apparatuses; and

FIG. 18 illustrates a graph showing temperature of a payload chamber over time for various exemplary insulated apparatuses.

### DESCRIPTION OF VARIOUS EMBODIMENTS

The following examples are presented in a non-limiting manner.

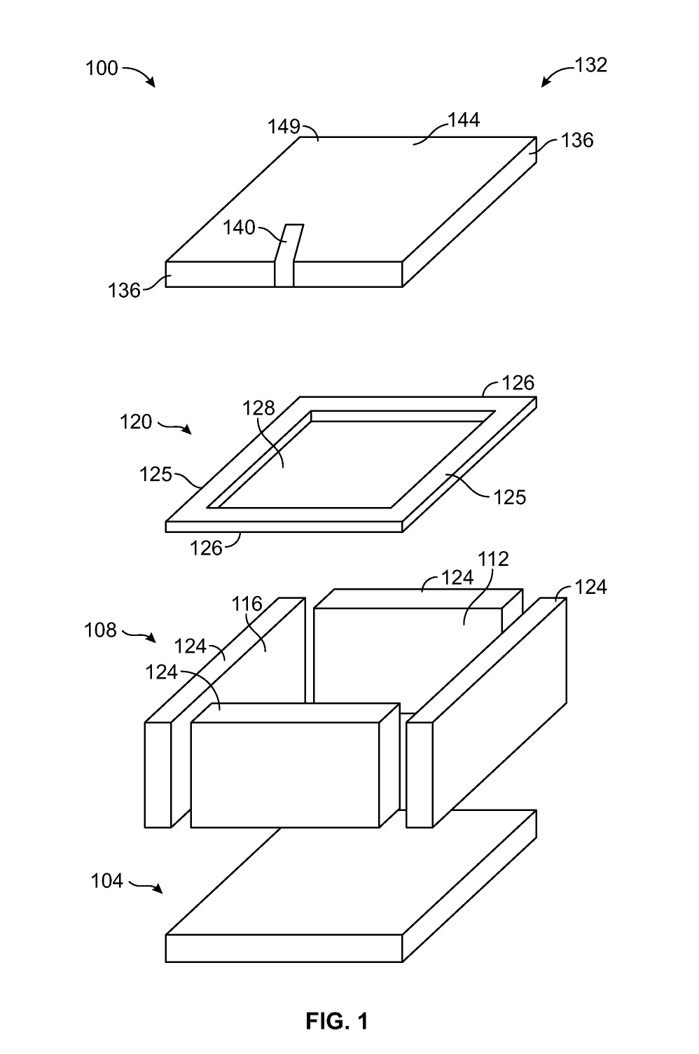

Referring now to FIG. 1, therein illustrated is an exploded view of an insulated inner container 100. The insulated inner container 100 has a base 104 and a plurality of upstanding walls 108 extending from the base 104. The inner surface of the upstanding walls 108 and the base 104 define a chamber 112. The top portions of the upstanding walls 108 define a chamber opening 116 in communication with the chamber 112. The base 104 and the upstanding walls 108 are formed of an insulated material. For example, the insulated material is selected from polyurethane, polyethylene, expanded polystyrene, extruded polystyrene, fiberglass, cork, foam, wood products, carbon, silica aerogels, and vacuum sealed fumed silica.

According to various exemplary embodiments, the base 104 and upstanding walls 108 are formed of discrete panels. For example, each of the discrete panels has a rectangular prism shape. One of the panels forms the base 104 of the inner container 100. Accordingly, the insulated inner container 100 can be assembled by arranging the upstanding wall panels 108 to form a rectangle and contacting the wall panels 108 with the base 104. For example, a first pair of panels form the opposing longitudinal walls and a second pair of panels form the opposing transverse walls of the inner container 100.

According to various exemplary embodiments, the base 104 and upstanding walls 108 are integrally formed to form the inner container 100. For example, the inner container 100 may be a rigid molded container.

According to various exemplary embodiments, the inner container 100 further optionally includes a lid member 120. The lid member 120 is positioned over the top surface 124 of the upstanding walls 108. For example, the lid member 120 is formed of material having one or more of thermoplastics, thermosetting polymers (ex: LDPE, HOPE, UHMWPE, PVC, PMMA, PLA, ABS, acrylic, nylon), corrugated paper and wood-based material. The lid member 120 includes parallel longitudinal portions 125 and parallel transverse portions 126 extending transversely to the longitudinal portions, which together define an inner opening 128. For example, the inner opening 128 has substantially the same size as the chamber opening 116. For example, the lid member 108 is positioned so that the inner opening 128 is aligned with the chamber opening 116. For example, the width of the parallel longitudinal portions 125 and parallel transverse portions 126 correspond to a thickness of the corresponding upstanding wall 108 covered by the lid member 120. The lid member 108 can be bonded to the top surfaces 124 of the upstanding walls 108. For example, acrylic, plastic, polyvinyl acetate glue or any other non-exothermic glues or epoxies can be used to bond the lid member 120 to the top surface 124 of the upstanding walls 108. For example, where the upstanding walls are formed of discrete panels, the bonding of the lid member 128 to the upstanding walls 108 improves the structural integrity of the joining of the wall panels. Furthermore, where the lid member 120 is formed in one piece, covering the top surface 124 of the upstanding walls 108 provides an aesthetic advantage because the lid member 120 hides from view the cracks formed from assembling the wall panels 108 to form the insulated inner container 100.

The insulated inner container 100 further includes a top panel 132, which forms a removable lid for selectively sealing the opening 116 defined by the upstanding walls 108. For example, the top panel 132 is formed of the same material as the base 104 and upstanding walls 108. For example, the planar area of the top panel 132 corresponds to an area of the opening 116 so that the top panel 132 can be inserted snugly within the upstanding walls 108 to seal the opening 116. For example, the sides 136 are inwardly tapered so that a bottom portion of the top panel 132 can fit between the upstanding walls 108 while the top panel 132 is prevent from sliding further towards the base 104.

According to various exemplary embodiments, the top panel 132 includes an attachment 140 attached thereto. For example, the attachment 140 is a pull-tab 140 extending from a top surface 144 of the top panel 132. Alternatively, the attachment 140 is a handle attached to a top surface 144 of the top panel 132. When the top panel 132 is fitted within the upstanding walls 108 to seal the opening 116, the attachment 140 is left exposed outside the insulated inner container 100. The attachment 140 aids in the removal of the top panel 132. For example, the top panel 132 can be removed to expose the inner chamber 112 by pulling on the attachment 140.

According to one exemplary embodiment, the top panel 132 includes a discontinuity formed in the top panel 132. For example, the discontinuity is in a side 136 of the top panel 132 or on the top surface 144 of the top panel 132. For example, the discontinuity is a hole or recess that allows insertion of a finger. The discontinuity aids in the removal of the top panel 132.

According to various exemplary embodiments, at least a portion of the insulated inner container 100 is enveloped in a wrapping layer. For example, the wrapping layer is formed of polymer film. For example, the wrapping layer is formed of polyolefin, polyethylene, PVC, PLA or polypropylene. The wrapping layer further improves insulating properties of the insulated inner container 100.

For example, where the insulated inner container 100 is a rigid molded container, the entirety of the insulated inner container 100 may be wrapped in the wrapping layer.

For example, where the base 104 and upstanding walls 108 of the insulated inner container 100 are formed of discrete panels, at least one of the plurality of insulating panels forming the base 104 and the upstanding panels 132 is enveloped in the wrapping layer. For example, the at least one panel is enveloped in the wrapping layer at atmospheric pressure. Alternatively, the at least one panel is enveloped in the wrapping layer at low pressure or is vacuum-sealed. For example, the at least one insulating panel can be shrink wrapped inside the wrapping layer. For example, the at least one insulating panel can be heat sealed within the wrapping layer. For example, the wrapping layer can be opaque so as to hide the texture of an outer surface of the insulating panel. Furthermore, the wrapping layer may increase the durability of the at least one insulating panel. For example, where the insulating panel is formed of a material that breaks up over time, the wrapping layer encloses the pieces of material falling from the insulating panel and prevents the pieces from entering into the chamber 112.

According to one exemplary embodiment, the coefficient of friction of an outer surface of the wrapping layer is greater than the coefficient of friction of an outer surface of the at least one insulating panel enclosed within the enclosure. Advantageously, where each of the base 104 and upstanding walls 108 are enclosed in the wrapping layer, the higher gripping outer surface of the enclosures improve structural integrity of the insulated inner container 100 when the base 104 and 108 are assembled together.

According to one exemplary embodiment, the top panel 132 is enveloped in a wrapping layer. For example, the top panel 132 is enveloped in the wrapping layer at atmospheric pressure. Alternatively, the top panel 132 is enveloped in the wrapping layer at low pressure or vacuum-sealed. For example, the top panel 132 can be shrink-wrapped inside the wrapping layer. For example, the top panel 132 can be heat sealed within the wrapping layer. For example, the wrapping layer can be opaque so as to hide the texture of an outer surface of the top panel 132. Furthermore, the wrapping layer may increase the durability of the top panel 132. For example, where the top panel 132 is formed of a material that breaks up over time, the wrapping layer encloses the pieces of material falling from the insulating panel and prevents the pieces from entering into the chamber 112. Moreover, where the coefficient of friction of an outer surface of the wrapping layer is greater than the coefficient of friction of an outer surface of the top panel 132, the higher gripping outer surface of the wrapping layer aids in retaining the top panel 132 when placed within the upstanding walls 108 to seal the inner chamber 112.

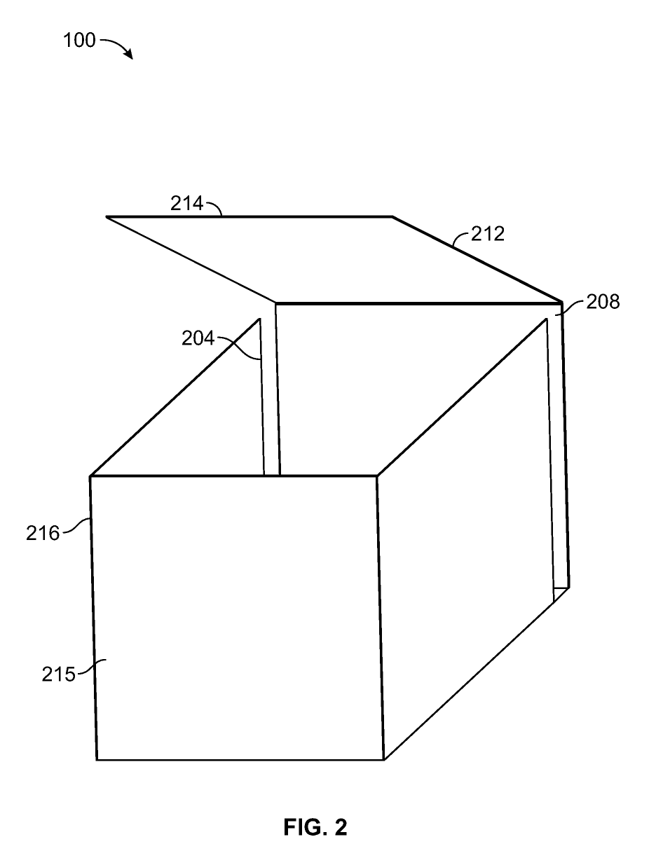

Referring now to FIG. 2, therein illustrated is a perspective view of an inner lining 200 according to various exemplary embodiments. The inner lining 200 is formed of at least one lining portion assembled to form a box-like or bag-like container. The formed container defines a payload chamber 204 having an opening 208. The inner lining 200 is formed of a material having low thermal conductivity.

According to various exemplary embodiments, the inner lining 200 is formed of material that has a thermal conductivity that is lower than the thermal conductivity of the material forming the insulated container 100. For example, the inner lining 200 is formed at least in part of material selected from aerogel, glass wool, corrugated paper, quartz silica gel, flexible foam, fiberglass composite material, flexible foam, flexible foam derived from polymers, wood foam, bubble wrap, fiber-based blanket, plant-derived fiber-based blankets, animal-derived fiber-based blankets and fiberglass composite material. For example, the inner lining 200 is formed of SPACELOFT™ aerogel provided by Aspen Aerogels (ex: approximately 0.013 W/mK at 22° C. and 1 atm). For example, the inner lining 200 is formed of GlassAir™ from McAllister Mills (CAS #65997-17-3) (ex: approximately 0.02 W/mK at 22° C. and 1 atm). For example, the inner lining 200 is formed of a malleable material.

According to various other exemplary embodiments, the inner lining 200 is formed of a material that has a thermal conductivity that is equal to or higher than the thermal conductivity of the material forming the insulated container 100.

According to various exemplary embodiments, the inner lining 200 has a low thickness compared to the thickness of the base 104 and upstanding walls 108 of the insulated inner container 100. This is due to the lower thermal conductivity of the inner lining 200, which allows an equivalent or better temperature-control performance of the inner lining 200 with a lower thickness compared to the insulated inner container 100. For example, the inner lining 200 has a thickness of less than 20 mm.

According to one exemplary embodiment, the inner lining 200 is formed of aerogel and has a thickness of about 4 mm to about 8 mm.

According to one exemplary embodiment, the inner lining 200 is formed of aerogel and has a thickness of about 8 mm to about 12 mm.

According to one exemplary embodiment, the inner lining 200 is formed of fiberglass composite material and has a thickness of about 12 mm to about 17 mm.

According to one exemplary embodiment, the inner lining 200 is formed of fiberglass composite material and has a thickness of about 17 to about 26 mm.

According to one exemplary embodiment, the inner lining 200 is formed of fiberglass composite material and has a thickness of up to about 52 mm or about 2 inches.

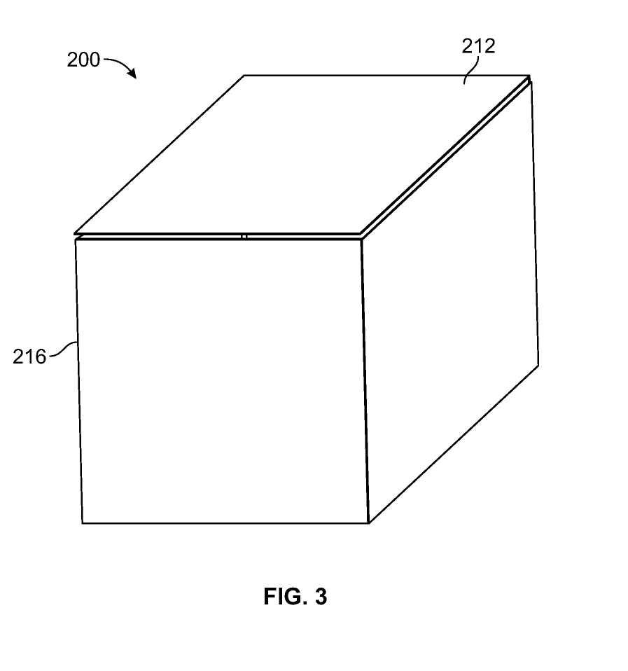

Referring now to FIGS. 2 and 3 together, illustrating a perspective view of the inner lining 200 in an open position and a closed position, respectively. According to various exemplary embodiments the inner lining 200 includes a flap portion 212. The flap portion 212 is movable between an open position and a closed position. In the open position, the flap portion 212 is moved away from the opening 208 to allow access to the payload chamber 204 through the opening 208. In the closed position, the flap 212 covers the opening 208 to substantially seal the payload chamber 204.

According to various exemplary embodiments, the size of the flap portion 212 is greater than an area of the opening 208. For example, when the flap portion 212 is moved to the closed position, a distal end 214 of the flap portion 212 can extend past an upstanding wall 215 of the inner lining 200. For example, the flap portion 212 can be partially inserted into the payload chamber 204 while still substantially sealing the opening 208. This may be useful where the payload only occupies a portion of the payload chamber 204. Accordingly, the flap portion 212 can be partially inserted into the payload chamber 204 to provide increased insulation.

According to various exemplary embodiments, the inner lining 200 may be formed of a unitary piece forming the box-like or bag-like container.

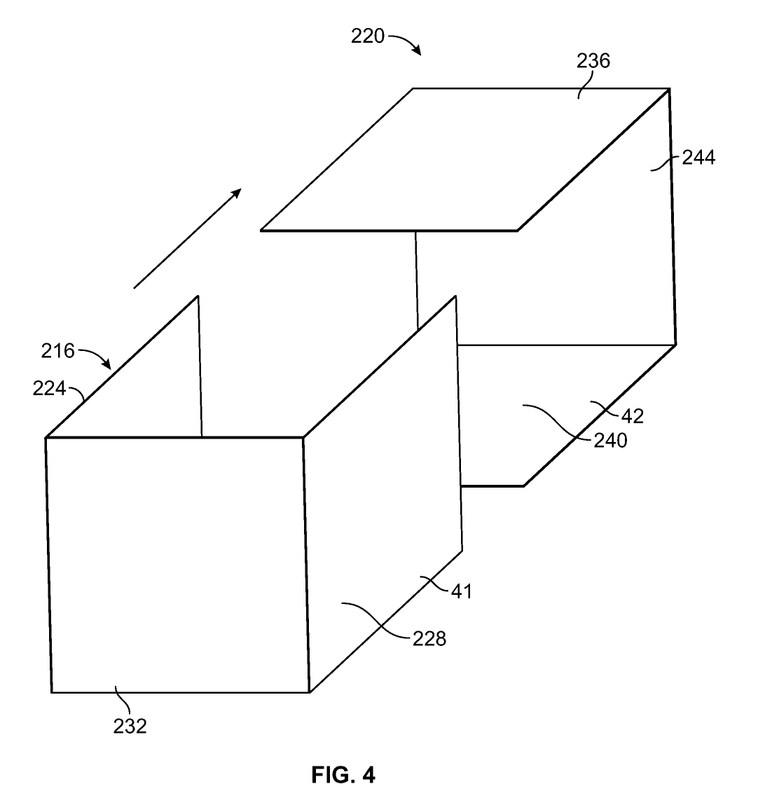

Referring now to FIG. 4, therein illustrated is an exploded view of an inner lining 200 according to various exemplary embodiments. According to such embodiments, the inner lining 200 is formed of a first panel 216 and a second panel 220. The first panel 216 is deformed to form the U-shape as shown. The first panel 216 includes a first sub-panel 224 and a second sub-panel 228 that are opposite one another. The first sub-panel 224 and second sub-panel 228 form opposing upstanding walls of the box-like inner lining 200. A third sub-panel 232 of the first panel 216 is coupled to the first and second sub-panels 224, 228 and form a third upstanding wall transverse to the opposing upstanding walls.

The second panel 220 includes a first sub-panel 236 and a second sub-panel 240 that are opposite one another. The first sub-panel 236 forms the flap portion 212 of the inner lining 200 once assembled. The second sub-panel 240 opposite the first sub-panel 236 forms a base portion of the inner lining 200. The third sub-panel 244 is coupled to the first and second sub-panels 236, 240 and forms a fourth upstanding wall opposite the third upstanding wall 232.

According to other exemplary embodiments the inner lining 200 may be formed of more than two pieces.

According to various exemplary embodiments, the inner lining 200 is enveloped in a wrapping layer. For example, each of the first panel 216 and second panel 220 are enclosed in respective wrapping layers. For example, each of the first panel 216 and the second panel 220 are enveloped in the wrapping layer at atmospheric pressure. Alternatively, each of the first panel 216 and the second panel 220 are enveloped in the wrapping layer at low pressure or are vacuum-sealed. For example, the inner lining 200 is shrink wrapped inside the wrapping layer. For example, the inner lining 200 is heat sealed inside the wrapping layer. For example, the thickness of the wrapping layer is about 1 millimeter to about 7 millimeters. For example, the low pressure wrapping layer can be opaque so as to hide the texture of an outer surface of the inner lining 200.

Furthermore, where the inner lining 200 is formed of a material that breaks up over time, the wrapping layer encloses the pieces of material falling from the inner lining 200 and prevents the pieces from entering into the payload chamber 204 or chamber 112 of the insulated inner chamber 100. For example, various types of materials used to form the inner lining 200 may contain one or more of fine fibers, small granules or particulate matter that may be harmful or at least difficult to clean or remove. Enclosing the inner lining 200 in the low pressure enclosure prevents such fibers, granules or particles from contaminating contents placed within the payload chamber 204, while also improving durability of the inner lining 200.

According to one exemplary embodiment, the first and second panels 216, 220 of the inner lining 200 have substantially the same dimensions. This may be the case where any opposing walls of the assembled inner lining 200 are squares. It will be appreciated that having similarly dimensioned first and second panels 216, 220 can decrease production costs.

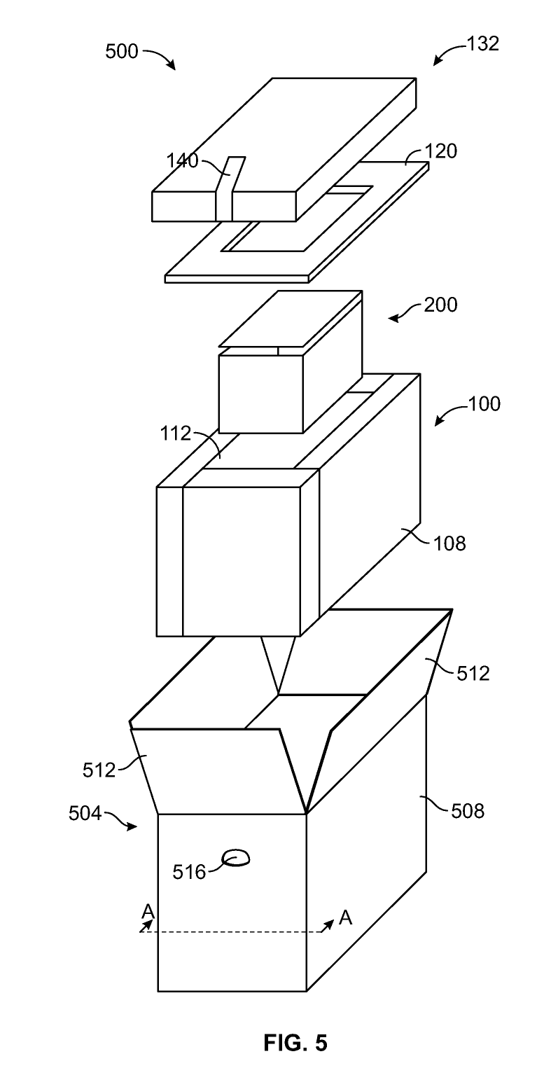

Referring now to FIG. 5, therein illustrated is an exploded view of an insulated storage apparatus 500 according to various exemplary embodiments. The storage apparatus 500 includes an outer container 504 defining an inner chamber 508. For example, the outer container 504 is formed of material typically used in transportation and storage applications, such as cardboard, laminated cardboard, plastics, corrugated plastics, etc. The outer container 504 is formed of a durable material that offers protection from the outside environment. According to some exemplary embodiments, the outer container 504 may have one or more accessories to facilitate handling, such as handles 516. For example, the outer container 504 has a plurality of foldable flaps 512 that can be folded to seal the inner chamber 508.

The insulated storage apparatus 500 further includes the insulated inner container 100 according to various exemplary embodiments described herein. The insulated storage apparatus 100 is disposed within the inner chamber 508. For example, where the insulated inner container 100 is formed of a plurality of panels, the insulated inner container 100 is pre-assembled before being inserted into the inner chamber 508. Alternatively, the panels may be assembled together within the inner chamber 508 of the outer container 504. According to various exemplary embodiments, the outer dimensions of the assembled insulated inner container 100 substantially correspond to the inner dimensions of the inner chamber 508. Accordingly, the insulated inner container 100 fits snugly within the outer container 504. The snug fit minimizes air gaps between outer surfaces of the insulated inner container 100 and the inner surface of the outer container 504, thereby reducing thermal conduction. When disposed within the inner chamber 508, the chamber 112 defined by the base 104 and upstanding walls 108 of the insulated inner container 100 represents a sub-chamber of the inner chamber 508 defined by the outer container 504.

The insulated storage apparatus 500 further includes the inner lining 200 according to various exemplary embodiment described herein. The inner lining 200 is disposed within the sub-chamber 112 of the insulated inner container 100 and covers an inner surface of the insulated inner container 100. According to various exemplary embodiments, the outer dimensions of the inner lining 200 substantially correspond to the inner dimensions of the sub-chamber 112. Accordingly, the inner lining 200 fits snugly within the inner container 100. The snug fit minimizes air gaps between outer surfaces of the inner lining 200 and the inner surface of the inner container 100, thereby reducing thermal conduction.

According to various exemplary embodiments, the inner lining 200 is pressfitted against inner surfaces of the base 104 and upstanding walls 108 of the insulated inner container 100. For example, adherence of the inner lining 200 to the inner surfaces of the insulated inner container 100 is improved due to the increased friction provided by the wrapping layer covering the insulated inner container 100 and the wrapping layer covering the inner lining 200. For example, press-fitting of the inner lining 200 to the inner surfaces of the insulated inner container 100 is further facilitated as the wrapping layer covering the insulated inner container 100 and the wrapping layer covering the inner lining 200 allows the inner lining 200 to be slid into the chamber 112 without damaging the container 100 or inner lining 200, for example, through chipping or breaking apart due to abrasion.

According to exemplary embodiments wherein the inner lining 200 is formed of a first panel 216 and a second panel 220, the first panel 216 is pressfitted to cover two opposed upstanding walls of the insulating inner container 100 and a third upstanding wall contacting both of the opposed upstanding walls. For example, first and second sub-panels 224, 228 cover the opposed upstanding walls while third sub-panel 232 covers the third upstanding wall. The second panel 220 is pressfitted to cover an inner surface of the base 104 and a fourth upstanding wall opposite the third upstanding wall. A free-moving portion of the second panel 220 forms the flap portion 212. For example, the second and third sub-panels 240, 244 cover an inner surface of the base 104 and the fourth upstanding wall respectively. The first sub-panel 236 extends from the third sub-panel 244 and forms the flap portion 212.

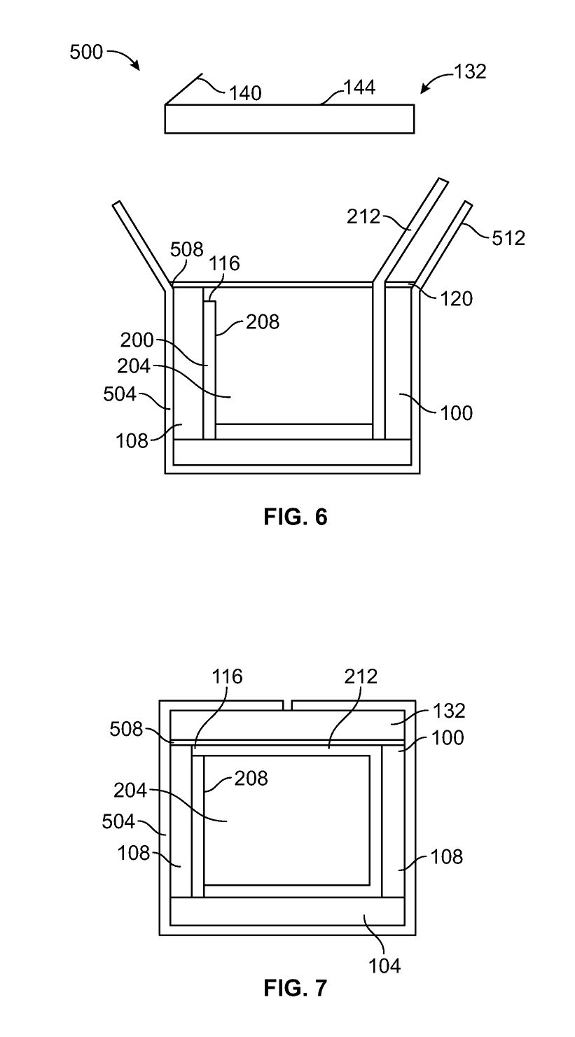

Referring now to FIG. 6, therein illustrated is a section view along the line A-A of the assembled insulated apparatus 500 according to various exemplary embodiments. As shown in FIG. 6, the base 104 and upstanding walls 108 are fitted snugly against an inner surface of the outer container 504. Furthermore, the inner lining 200 is fitted snugly against an inner surface of the insulated container 100. The payload chamber 204 defined by the inner lining 200 provides a space for storing content within the insulated storage apparatus 500. It will be appreciated that the payload chamber 204 is shielded by three different layers of materials, these three layers being the outer container 500, the insulated container 100 and the inner lining 200.

The insulated apparatus 500 is illustrated in FIG. 6 as being in an open position. In the open position, the flap portion 212 is moved to its open position to expose the opening 208 of the inner lining 200. In the open position, the top panel 132 of the insulated container 100 is further removed to expose the opening 116 of the insulated inner container 100. In the open position, the flap portions 512 of the outer container 500 are further moved to their open positions to expose the opening 508.

It will be further appreciated that when the insulated storage apparatus 500 is assembled by disposing the insulated inner container 100 within the outer container 500 and, by further disposing the inner lining 200 within the insulating inner container 100, the opening 508 of the outer container 500, the opening 116 of the insulated inner container 100 and the opening 208 of the inner lining 200 are substantially aligned. When placing content into the payload chamber 204 of the inner lining 200, the content is passed through each of the opening of the outer container 504, opening 116 of the insulated container 100 and the opening 208 of the inner lining 200.

Referring now to FIG. 7, therein illustrated is a section view along the line A-A of the assembled insulated apparatus 500 in a closed position according to various exemplary embodiments. In the closed position, the flap portion 212 of the inner lining 200 is moved to its closed position to seal the opening 208 of the inner lining 200. In the closed position, the top insulating panel 132 is placed to abut against top surfaces of the upstanding walls 108 of the insulated container 100. Accordingly, the top insulating panel 132 seals the opening 112 of the insulating container 100. When sealing the opening 112, the top panel 132 can be positioned such that an inner surface of the top panel 132 closely contacts a top surface of the flap portion 212, thereby minimizing air gaps and minimizing thermal conduction. In the closed position, the flap portions 512 of the outer container 504 are further moved to their closed position to cover an outer surface of the top panel 132 and to seal opening 508 of the outer container 500. The flap portions may be further sealed using appropriate sealing material such as tape.

It will appreciated that when the assembled insulated apparatus 500 is in the closed position, the payload chamber 204 is substantially shielded in all directions by three different layers of materials, these three layers being the outer container 500, the insulated container 100 and the inner lining 200. For example, where the insulated apparatus 500 is a rectangular prism, the payload chamber 204 is shield in all six directions, including in the direction of the openings 116, 208.

When in use, material (payload) to be stored or transported is placed within the payload chamber 204. An appropriate amount of temperature-maintaining substance can also be placed within the payload chamber 204 to aid in maintaining the payload chamber 204 within a desired range of temperatures. The flap portion 212 is then moved to the closed position to seal the payload chamber 204, the top panel 132 is then moved to its closed position to seal the chamber 112 and the flaps 512 of the outside container are folded to the closed position in order to properly shield the payload and the low-temperature substance.

For example, to maintain temperature within the payload chamber 204 at a desired range of temperatures below 0° C., dry ice can be used as the temperature maintaining substance. For example, to achieve a desired range of temperatures between about 2° C. and about 8° C., refrigerants including a combination of phase change material and low temperature substance, such as ice packs, can be used as the temperature-maintaining substance. It will be appreciated that temperature maintaining substances including, but not limited to dry ice, ice packs, and phase change materials, may be included in varying amounts to maintain temperature within the payload chamber 204 at a variety of different ranges of temperature.

Advantageously, use of an inner lining 200 having a thermal conductivity that is lower than the thermal conductivity of the insulated container 100 allows the dimensions of the insulated apparatus 500 and/or weight of the insulated apparatus 500 to be decreased versus conventional temperature-controlled apparatus while maintaining at least equivalent temperature-control performance and payload capacity. Due to its lower thermal conductivity, equivalent temperature-control performance can be achieved using a lower thickness of the inner lining 200 when compared to the material used for the insulated inner container 100. For example, in one exemplary embodiment, the temperature control performance of a conventional apparatus was achieved using an insulated apparatus 500 according to various exemplary embodiments described herein having an outer volume that was 30% less than the outer volume of the conventional apparatus while providing substantially the same payload capacity.

Advantageously, use of three different layers of materials in the insulated storage apparatus 500 provides greater adaptability of the insulated storage apparatus 500 for the varying requirements that may arise in different temperature-controlled storage and shipping applications.

The material forming the outer layer provided by the outer container 504 can be selected according to a durability requirement presented by a particular application. While the outer container 504 principally serves to protect inner contents of the insulated storage apparatus 504 from the outside environment, the required amount of protection provided may vary depending on the application. For example, in some applications, it may be a requirement that the storage apparatus 500 have high durability. This may be the case in applications where the insulated storage apparatus 500 will be used more than once (reusable). For example, in such applications, a highly durable material such as corrugated plastic may be selected to form at least part of the outer container 504. Other appropriate materials known in the art may be used for such applications. For example, high durability may be a requirement in highly regulated industries, such as blood services. High durability may also be a requirement in industries that will use the storage apparatus 500 multiple times, such as food services. High durability may also be a requirement in industries where shipments are made internally within an organization, thereby resulting in repeated use of the storage apparatus 500. High durability may further be a requirement in industries where the payload is of a high value, and the shipper wants to minimize any risk that the payload may be damaged during shipment. This may be the case for specialized laboratory services.

For example, in other applications, low-cost of materials may be more important than durability. This may be the case in applications where the insulated storage apparatus 500 will be used only once. For example, in such applications, a lower durable material such as cardboard or laminated cardboard may be selected to form at least part of the outer container 504. Other appropriate materials known in the art may be used for such applications. Furthermore, cardboard or laminated cardboard are low cost and environmentally friendly. For example, low cost may be a requirement in industries that do not ship in large volumes, such as gene therapy laboratories. For example, low cost may be a requirement in industries that make shipments to a large number of customers. For example, low cost may be a requirement in any industry where shipments are made in a one-way direction.

Similarly, the material forming the intermediate layer provided by the insulated inner container 100 can be selected according to a durability requirement. For applications requiring higher durability, a highly durable insulating material such as polyurethane may be selected to form the insulated inner container 100.

In other applications where low-cost of materials may be more important than durability, a lower-cost insulating material such as expanded polystyrene may be selected to form the inner container 100.

According to various exemplary embodiments, the material forming the inner layer provided by the inner lining 200 can be selected according to a desired temperature retention duration. Temperature retention duration herein refers to the duration of time at which the temperature within the payload chamber 204 of the insulated storage apparatus 500 can be maintained below a particular temperature set-point. For example, temperature retention duration requirements may be defined by the time of transportation of the payload (ex: estimated delivery times for a particular delivery service), expected delays in transportation (ex: a package being temporarily held at a border crossing), and/or the nature of the contents of the payload (ex: contents must remain at below freezing point).

For example, in some applications, it may be a requirement that the insulated storage apparatus 500 have a high temperature retention duration, for example, greater than 96 hours. In such applications, a material having low thermal conductivity, such as aerogel (Aspen Aerogel) may be selected to form the inner lining 200. Similarly, a better insulating material such as polyurethane may be selected to form the insulated inner container 100. For example, high temperature retention may be a requirement in applications where highly valuable contents are being stored or transported. In such applications, maximizing temperature retention duration reduces the risk of the contents being compromised due to any unexpected delays. This reduction of risk may justify the higher cost of the low thermal conductivity material. This may be the case for specialized laboratory services. High temperature retention duration may also be a requirement in applications where contents will be stored or transported for an extended duration of time. This may be the case for industries where contents are to be shipped over great distances or internationally.

For example, in other applications, a relatively lower temperature retention duration may be required, for example, less than 48 hours. In such applications, a material having relatively higher thermal conductivity, such as GlassAir from McAllister Mills, may be selected to form the inner lining 200. Similarly, a relatively poorer insulating material, such as extruded polystyrene foam, may be selected to form the insulated inner container 100. For example, relatively lower temperature retention duration may be acceptable in applications where relatively less valuable contents are being stored or transported and some loss of the contents is acceptable. In such applications, the cost savings in using the less costly material for the inner lining 200 may outweigh the costs of loss of contents. This may be the case for the frozen food industries, where some spoilage is acceptable. This may also be the case for industries that have a high volume of one-way shipments of contents of relatively lower value.

According to various exemplary embodiments, the material forming the inner layer provided by the inner lining 200 can be selected according to a weight requirement for the insulated storage apparatus 500. For example, in some applications, it may be a requirement that the insulated storage apparatus 500 have a lesser weight so as to minimize shipping costs. In such applications, a material having a lower density may be selected to form the inner lining 200. For example, GlassAir™ from. McAllister Mills may be a better choice in such situations because the density of GlassAir™ from McAllister Mills (˜80 kg/m³) is substantially lower than the density of SPACELOFT™ aerogel (˜150 kg/m³). For example, lesser weight may be a requirement in applications where the payload is of a lesser value and therefore needs to be shipped in a low-cost manner.

According to various exemplary embodiments, the thickness of the inner lining 200 can be selected according to a desired temperature retention duration. In applications that require a high temperature retention duration, a thicker layer of the material having low thermal conductivity may be selected to form the inner lining 200. It has been observed that a thicker inner lining 200 can increase the desired temperature retention duration. According to one test, it was observed that doubling the thickness of the inner lining 200 provided an approximately 80% increase in the temperature retention duration. This may be useful in applications where protecting the contents being stored or transported is critical so as to justify the increase in cost in increasing the thickness of the inner lining 200.

According to a process for fabricating the insulated storage apparatus 500, the outer container 504 is provided. The size of the outer container 504 can be selected according to desired dimensions of the payload to be stored or transported.

According to the process, the inner insulated container 100 is provided and inserted within the inner chamber 508 defined by the outer container 504. For example, outer dimensions of the inner insulated container 100 substantially correspond to inner dimensions of the outer container 504. For example, the inner insulated container 100 fits snugly within the inner chamber 508. The inner insulated container 100 is formed of a first insulating material.

According to various exemplary embodiments wherein the inner insulated container 100 is formed of discrete panels, the base panel 104, upstanding wall panels 108 and a top panel 132 are formed from a first insulating material. The dimensions of the panels 104, 108 and 132 are selected according to the interior dimensions of the outer container 504 so that an insulated container 100 assembled therefrom fits snugly within the inner chamber 508. After forming the base panel 104, upstanding wall panels 108 and top panel 132, the panels are assembled to form the inner container 100.

According to various exemplary embodiments, the type of first insulating material to be used to form the inner insulated container 100 is selected according to a predetermined durability requirement. For example, the durability requirement can be indicated via an external user selection. For example, if the predetermined durability requirement indicates reusability of the storage apparatus, polyurethane foam is selected as the first insulating material and if the predetermined durability requirement indicates disposability of the storage apparatus, polystyrene foam is selected as the first material.

According to various exemplary embodiments, the inner insulated container 100 is enveloped in a wrapping layer. For example, when forming the panels 104, 108, and 132, each of the panels are enveloped within enclosure wrapping layer according to various examples described herein.

According to the process, the inner lining 200 is formed of a second type of insulating material. For example, a first panel of the inner lining and a second panel of the inner lining are formed according to interior dimensions of the insulated container 100.

According to the process, the inner lining 200 is inserted within the chamber 112 defined by the insulated inner container 100. For example, the inner lining 200 is adhered to the inner surfaces of the insulated inner container 100. According to exemplary embodiments wherein the inner lining 200 is formed of first and second panels, the first panel is adhered to the inner surface of the insulated inner container 100 to cover two opposite upstanding walls panels 108 and a third wall panel contacting the two opposite upstanding walls. The second panel is adhered to the inner surface of the insulated inner container 100 to cover a base panel and a fourth wall panel opposing the third wall panel. The first panel and the second panel together form the inner lining 200 of the insulated storage apparatus 500. A remainder of the second panel forms a flap for sealing an opening of the inner lining 200, thereby also sealing an opening of the insulated inner container defined by the upstanding walls 108.

According to various exemplary embodiments, the inner lining 200 is enveloped within a wrapping layer. For example, when forming the first and second panels of the inner lining 200, each of the panels is enclosed within the wrapping layer according to various examples described herein.

According to various exemplary embodiments, the forming of the inner lining 200 from the second insulating material and the insertion of the inner lining 200 into the insulated inner container 100 is carried out selectively based on a weight or density requirement. Some applications have a stringent weight requirement necessitating a lighter insulating storage apparatus 500. This may be the cases where cost of shipping by weight may be high. The predetermined weight threshold corresponds to a threshold at which the inner lining 200 is required in order to obtain an insulated storage apparatus 500 having a weight or density within acceptably low weight limits. Where the weight requirement of a particular application is below the predetermined weight threshold, the forming of the inner lining 200 from the second insulating material and the insertion thereof into the inner container 100 carried out. Where the weight requirement of a particular application exceeds the predetermined weight threshold, the forming of the inner lining 200 is not carried out and the required temperature retention duration is achieved by selecting an appropriate thickness of the first insulating material forming the inner container 100.

According to various exemplary embodiments, the forming of the inner lining 200 from the second insulating material and the insertion thereof into the inner container 100 are carried out selectively based on a first predetermined temperature retention duration requirement. As described herein, a trade-off exists between the thickness of the first insulating material forming the insulated inner container 100 and the second insulating material forming the inner lining 200. Some applications have a stringent temperature retention duration necessitating addition of insulating material having lower thermal conductivity. The first predetermined temperature retention duration threshold corresponds to a particular duration of time at which the inner lining 200 is required in order to obtain an insulated storage apparatus 500 having a temperature retention duration that exceeds that particular duration of time. Where the temperature retention duration exceeds the first predetermined temperature retention duration threshold, the forming of the inner lining 200 from the second insulating material and the insertion thereof into the inner container 100 are carried out. Where the temperature retention duration requirement of a particular application is below the first predetermined temperature retention duration threshold, the forming of the inner lining 200 is not carried out and the required temperature retention duration is achieved by selecting an appropriate thickness of the first insulating material forming the inner container 100.

According to various exemplary embodiments, the process further includes selecting the type of the second material according to the predetermined temperature retention duration requirement of a particular temperature-controlled storage or transportation application. As described herein, different materials of the inner lining 200 can achieve different temperature retention durations. The second predetermined temperature retention duration threshold corresponds to a threshold at which a first type (ex: lower cost) of insulating material forming the inner lining 200 is unable to provide the particular second temperature retention duration and a second type of insulating material having a lower thermal conductivity is required to achieve the required temperature retention duration. Where the temperature retention duration requirement exceeds the first predetermined temperature retention duration threshold (thereby requiring an inner lining 200), but is shorter than the second temperature retention duration, the first type or category of second insulating material is selected for forming the inner lining 200. Where the temperature retention duration exceeds the second temperature retention duration threshold (thereby requiring an inner lining 200 having a lower thermal conductivity), the second type or category of second insulating material is selected for forming the inner lining 200. For example, the insulating material of the second type or category has a lower thermal conductivity than the first type or category of insulating material. For example, the first type of insulating material includes GlassAir from McAllister Mills and the second type of insulating material includes aerogel.

### Experiment 1

According to a first experiment, insulated storage apparatuses 500 having different thicknesses of the inner lining formed of a same insulating material were tested for temperature retention duration.

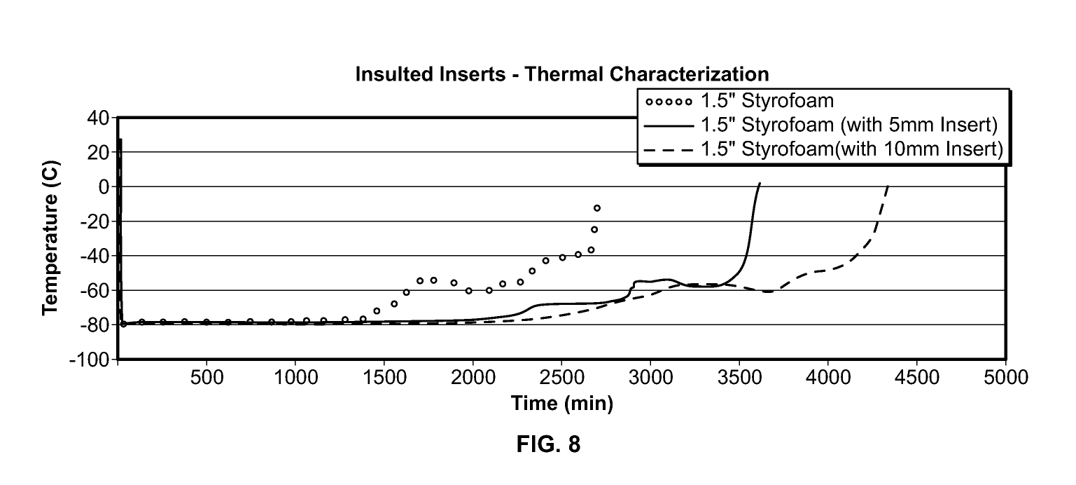

FIG. 8 illustrates a graph showing temperature within the payload chamber 204 for different insulated storage apparatuses 500 placed in an environment having an ambient temperature of approximately 22° C.

It was observed that an insulated storage apparatus 500 having an insulated container 100 of a first set of properties and having no inner lining 200 was able to retain a temperature of below −40° C. within the payload chamber 204 for a duration of approximately 2600 minutes when 2.3 kg of dry ice are inserted into the payload chamber.

It was further observed that a second insulated storage apparatus 500 having an insulated container 100 of the first set of properties and having an inner lining 200 formed of an insulating material (SPACELOFT™) having a thermal conductivity below (0.013 W/mK) and a thickness of 5 mm was able to retain a temperature of below −40° C. within the payload chamber 204 for a duration of approximately 60 hours when 2.3 kg of dry ice are inserted into the payload chamber.

It was further observed that a third insulated storage apparatus 500 having an insulated container 100 of the first set of properties and having an inner lining 200 formed of the insulating material (SPACELOFT™) having a thermal conductivity below (0.013 W/mK) and a thickness of 10 mm was able to retain a temperature of below −40° C. within the payload chamber 204 for a duration of approximately 70 hours when 2.3 kg of dry ice are inserted into the payload chamber.

### Experiment 2

According to a second experiment, insulating storing apparatuses 500 having different insulating materials forming the inner lining 200 and different amounts of the temperature maintaining substance were tested for temperature retention duration.

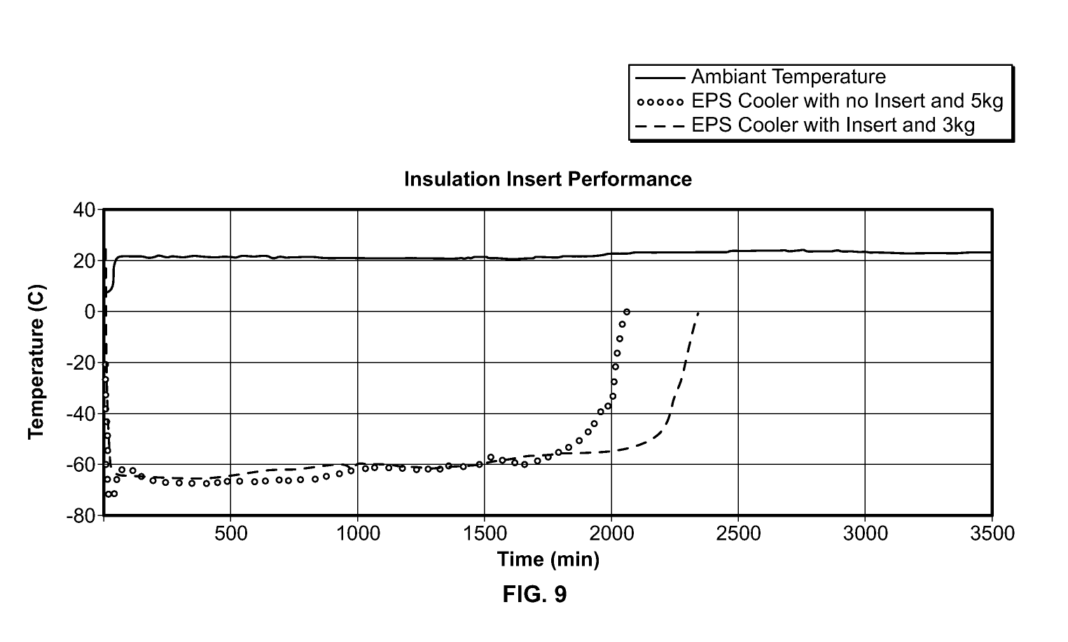

FIG. 9 illustrates, a graph showing temperature within the payload chamber 204 for different insulated storage apparatuses 500 having different amounts of temperature maintaining substances, the insulated storage apparatuses being placed in an environment having an ambient temperature of approximately 22° C.

It was observed that a fourth insulated storage apparatus 500 having an insulated container 100 of a second set of properties, no inner lining 200 and 5 kg of dry ice was able to retain a temperature of below −40° C. within the chamber 112 for a duration of approximately 1950 minutes.

It was further observed that a fifth insulated storage apparatus 500 having an insulated container 100 of the second set of properties, an inner lining 200, and 3 kg of dry ice was able to retain a temperature below −40° C. within the chamber 112 for a duration of approximately 2230 minutes.

It was observed that providing the inner lining 200 within the fifth insulated storage apparatus 500 increased the temperature retention duration by approximately 14.4% while reducing the amount of dry ice required by 40% when compared to the fourth insulated storage apparatus.

### Experiment 3

According to a third experiment, insulating storing apparatuses 500 having different insulating materials forming the inner lining 200 and different amounts of the temperature maintaining substance were tested for temperature retention duration.

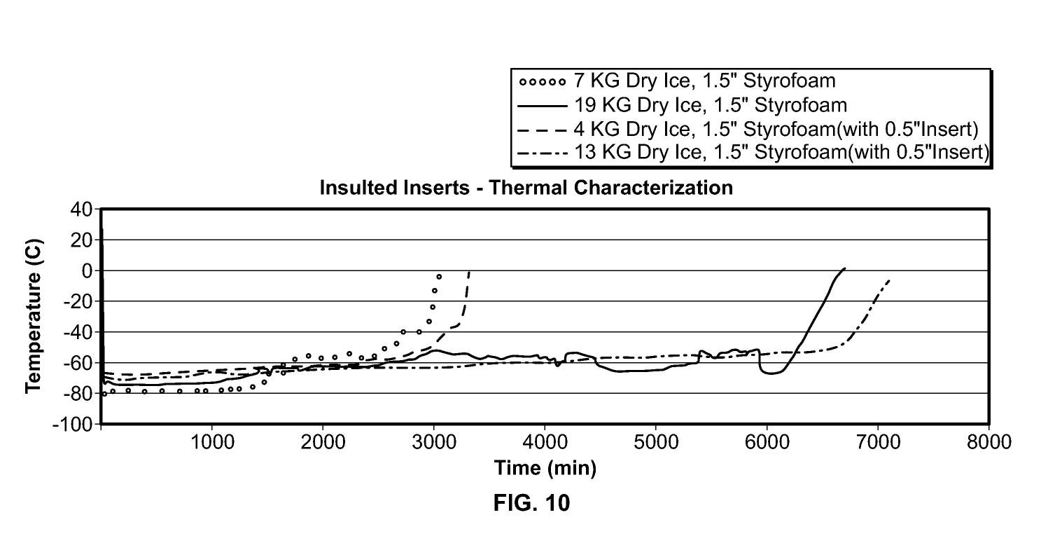

FIG. 10 illustrates a graph showing temperature within the payload chamber 204 for different insulated storage apparatus 500 having different amounts of temperature maintaining substances, the insulated storage apparatuses being placed in an environment having an ambient temperature of approximately 22° C.

It was observed that a sixth insulated storage apparatus 500 having an insulated container 100 of a third set of properties, no inner lining 200 and 7 kg of dry ice was able to retain a temperature of below −40° C. within the chamber 112 for a duration of approximately 2700 minutes.

It was further observed that a seventh insulated storage apparatus 500 having an insulated container 100 of the third set of properties, an inner lining 200 and 4 kg of dry ice was able to retain a temperature below −40° C. within the chamber 112 for a duration of approximately 3100 minutes.

It was further observed that a seventh insulated storage apparatus 500 having an insulated container 100 of a fourth set of properties, no inner lining 200 and 18.8 kg of dry ice was able to retain a temperature of below −40° C. within the chamber 112 for a duration of approximately 6400 minutes.

It was further observed that an eighth insulated storage apparatus 500 having the an insulated container 100 of the fourth set of properties, an inner lining 200 and 13 kg of dry ice was able to retain a temperature of below −40° C. within the chamber 112 for a duration of approximately 6800 minutes.

### Experiment 4

According to a fourth experiment, insulating storing apparatuses 500 having different insulating materials forming the inner lining 200 and different amounts of the temperature maintaining substance were tested for temperature retention duration.

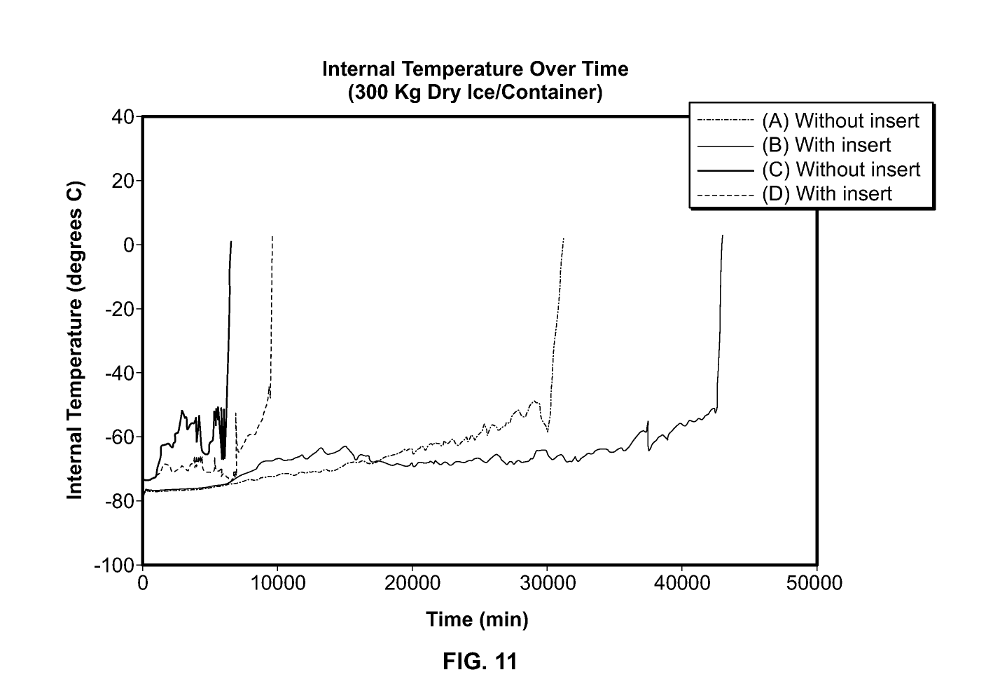

FIG. 11 illustrates a graph showing temperature within the payload chamber 204 for different insulated storage apparatus 500 having different amounts of temperature maintaining substances, the insulated storage apparatuses being placed in an environment having an ambient temperature of approximately 22° C.

It was observed that a ninth insulated storage apparatus 500 having an insulated container 100 of a fifth set of properties, no inner lining 200 and a first given amount of dry ice was able to retain a temperature of below −40° C. within the chamber 112 for a duration of approximately 32000 minutes.

It was further observed that a tenth insulated storage apparatus 500 having an insulated container 100 of the fifth set of properties, an inner lining 200, the same first given amount of dry ice was able to retain a temperature below −40° C. within the chamber 112 for a duration of approximately 43800 minutes.

It was further observed that an eleventh insulated storage apparatus 500 having an insulated container 100 of a sixth set of properties, no inner lining 200, and a second given amount of dry ice was able to retain a temperature below −40° C. within the chamber 112 for a duration of approximately 7000 minutes.

It was further observed that a twelfth insulated storage apparatus 500 having an insulated container 100 of the sixth set of properties, an inner lining 200, and the same second given amount of dry ice was able to retain a temperature below −40° C. within the chamber 112 for a duration of approximately 10000 minutes.

### Experiment 5

According to a fifth experiment, insulating storing apparatuses 500 having different insulating materials forming the inner lining 200 and different amounts of the temperature maintaining substance were tested for temperature retention duration.

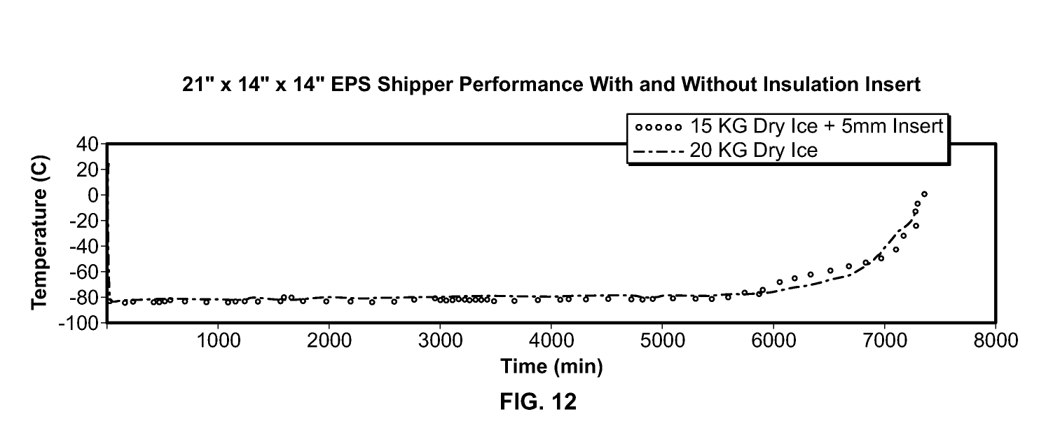

FIG. 12 illustrates a graph showing temperature within the payload chamber 204 for different insulated storage apparatus 500 having different amounts of temperature maintaining substances, the insulated storage apparatuses being placed in an environment having an ambient temperature of approximately 22° C.

It was observed that a thirteenth insulated storage apparatus 500 having a an insulated container 100 of a seventh set of properties, no inner lining 200 and 20 kg dry ice was able to retain a temperature of below −40° C. within the chamber 112 for a duration of approximately 7000 minutes.

It was further observed that a fourteenth insulated storage apparatus 500 having an insulated container 100 of the seventh set of properties, an inner lining 200, 15 kg of dry ice was able to retain a temperature below −40° C. within the chamber 112 for a duration of approximately 7000 minutes.

It was observed that providing the inner lining 200 within the fourteenth insulated storage apparatus 500 reduced the overall weight of the insulated storage apparatus by 25% while achieving substantially the same temperature retention duration when compared to the fourteenth insulated storage apparatus 500.

### Additional Experiments

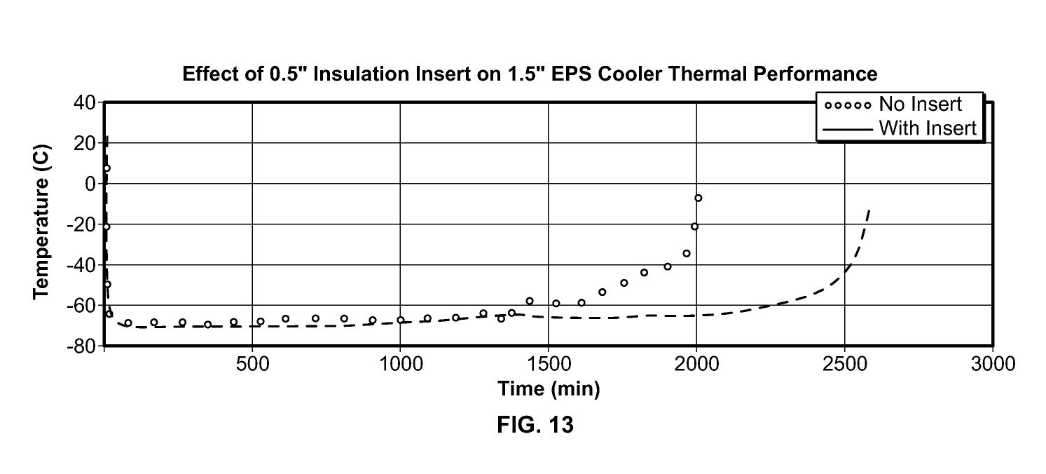

FIG. 13 illustrates a graph showing temperature within the payload chamber 204 with and without a 0.5″ thick inner lining under equal coolant conditions. It was observed that a temperature of below −60° C. was maintained for approximately 600 minutes longer when the inner lining is used.

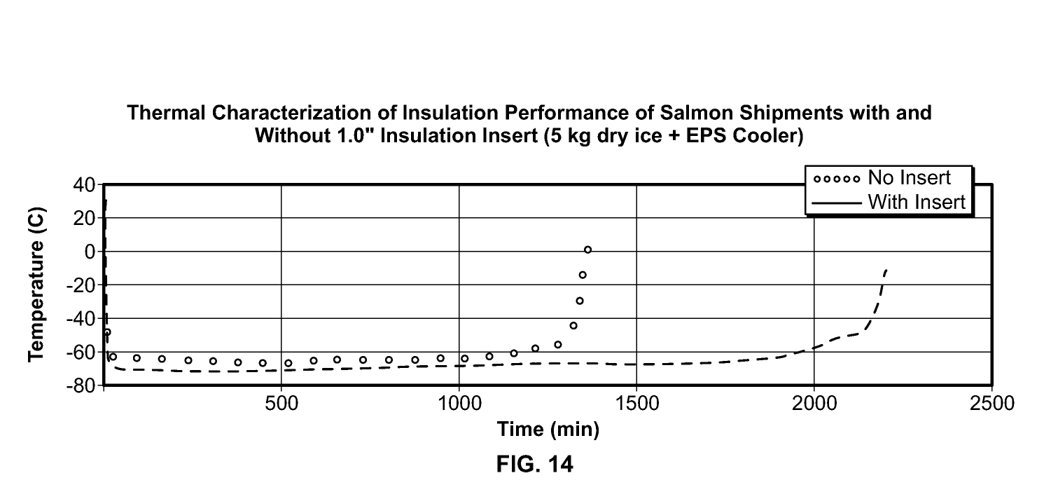

FIG. 14 illustrates a graph showing temperature within the payload chamber 204 with and without a 1″ thick inner lining under equal coolant conditions. It was observed that a temperature of below −60° C. was maintained for substantially longer when the inner lining is used.

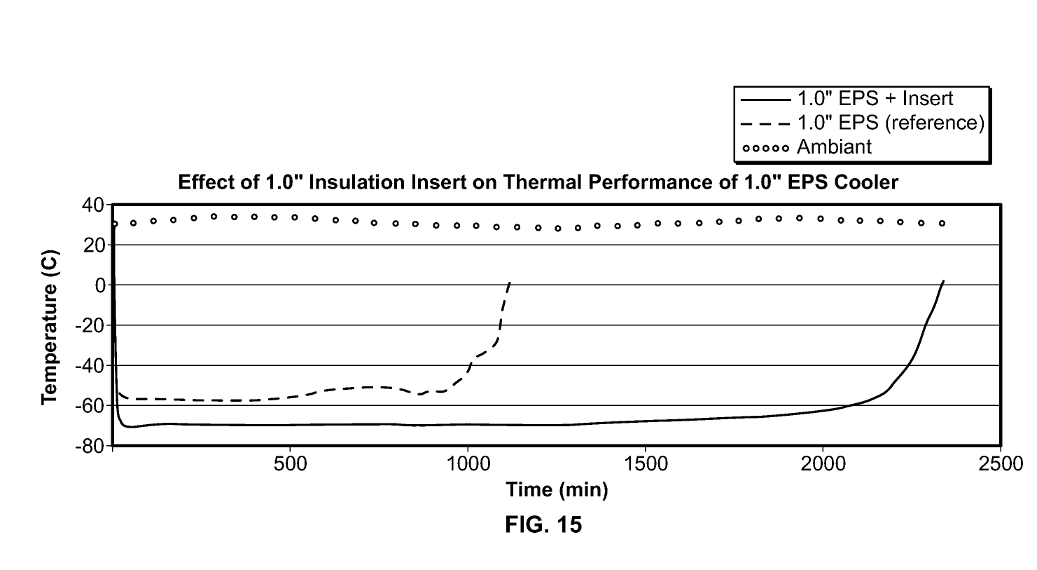

FIG. 15 illustrates a graph showing temperature within the payload chamber 204 with and without a 1″ thick inner lining used in conjunction with an EPS insulator under equal coolant conditions. It was observed that a temperature of below −60° C. was maintained for substantially longer when the inner lining is used.

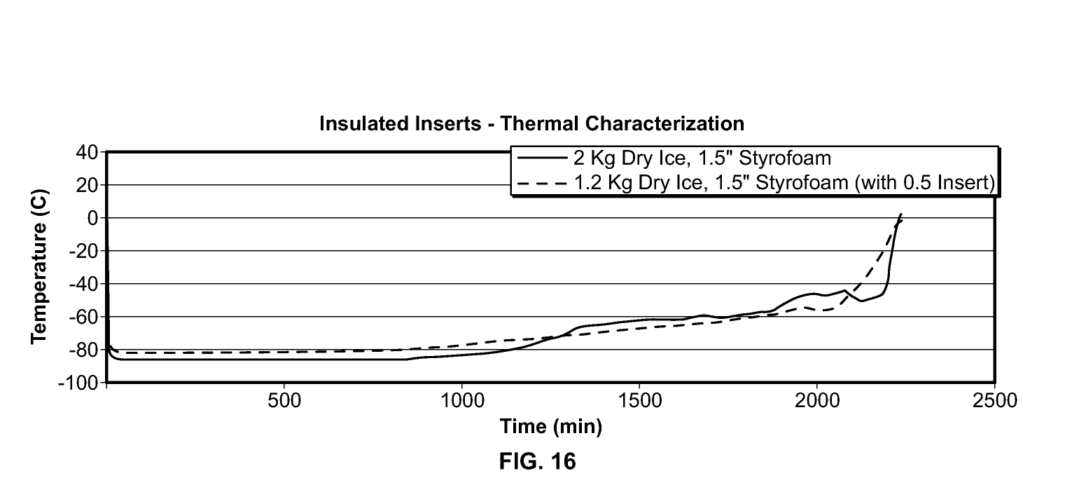

FIG. 16 illustrates a graph showing temperature within the payload chamber 204 with and without a 0.5″ thick inner lining for different coolant weight conditions. It was observed that more coolant was required when the inner lining is absent to achieve comparable temperature maintenance performance as when the inner lining is used with a lesser amount of coolant.

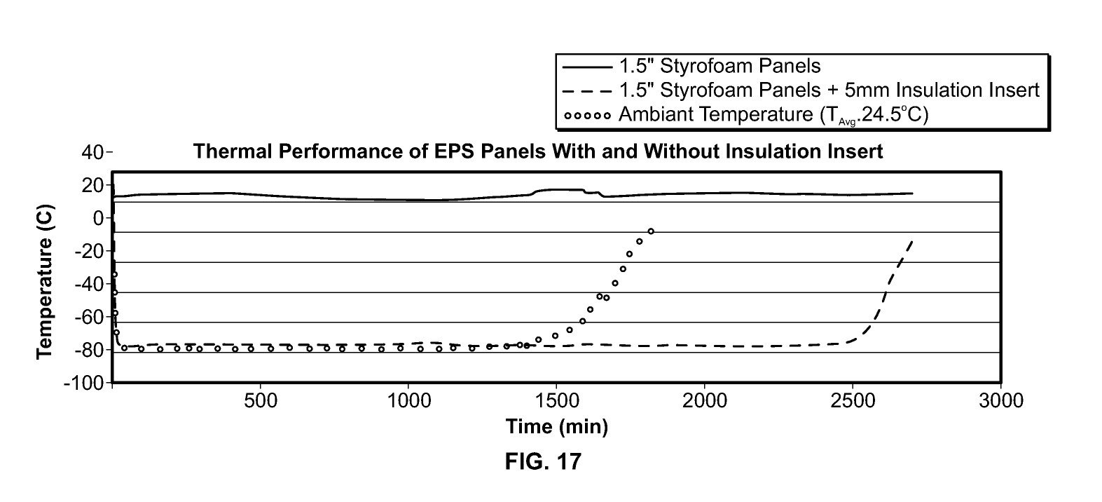

FIG. 17 illustrates a graph showing temperature within the payload chamber 204 with and without 5 mm inner lining used in conjunction with Styrofoam panels under equal coolant conditions. It was observed that a temperature of approximately −80° C. was maintained for substantially longer when the inner lining is used.

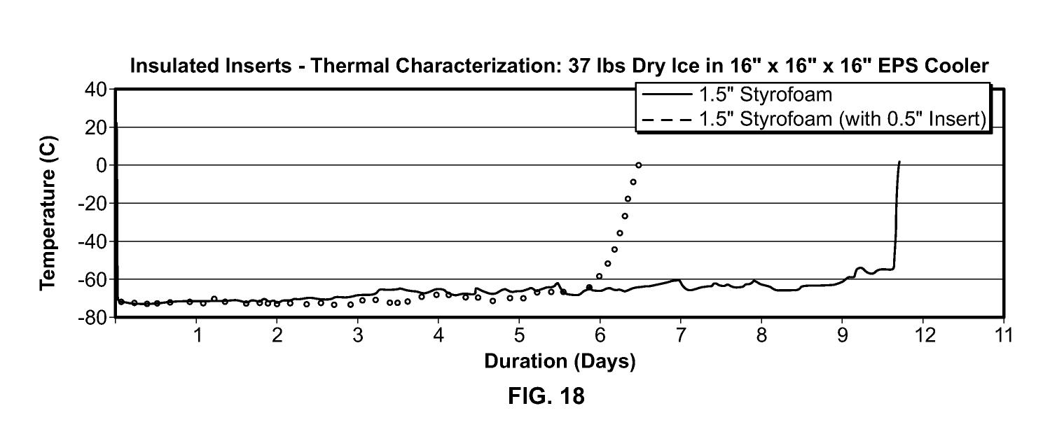

FIG. 18 illustrates a graph showing temperature within the payload chamber 204 with and without a 0.5″ inner lining used in conjunction with Styrofoam panels under equal coolant conditions. It was observed that a temperature of below −60° C. was maintained for substantially longer when the inner lining is used.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the disclosure as defined in the claims appended hereto.

1. An insulated apparatus comprising:
an outer container defining an inner chamber;
an insulated container disposed within the inner chamber, the insulated container comprising a base and upstanding walls extending from the base;
an inner insulating lining covering an inner surface of the insulated container, the inner lining further defining a payload chamber.

2. The insulated apparatus of claim 1, wherein the thermal conductivity of the inner lining is lower than the thermal conductivity of the insulated container.

3. The insulated apparatus of claim 2, wherein the inner lining is formed of a material selected from aerogel, glass wool, corrugated paper, quartz silica gel, flexible foam, flexible foam derived from polymers; wood foam, bubble wrap, fiber-based blanket; plant-derived fiber-based blankets, animal derived fiber-based blankets, and fiberglass composite material.

4. The insulated apparatus of claim 3, wherein the inner lining has a thickness of less than about 52 mm.

5. The insulated apparatus of claim 1, wherein the inner lining further comprises a flap portion extending from a portion of the lining covering one of the upstanding walls, the flap being movable between an open position and a closed position, in the open position the flap exposing an opening defined by the upstanding walls to provide access to the payload chamber, and in the closed position the flap closing the opening to substantially seal the payload chamber.

6. The insulated apparatus of claim 5, wherein the inner lining is formed of a first part and a second part, the first part covering two opposed upstanding walls of the insulating container and a third upstanding wall contacting both of the opposed upstanding walls, and the second part covering the base, a fourth upstanding wall opposite the third upstanding wall, and forming the flap portion.

7. The insulated apparatus of claim wherein the inner lining is pressfitted to adhere to the insulated container.

8. The insulated apparatus of claim 1, wherein the inner lining is enclosed in a wrapping layer.

9. The insulated apparatus of claim 8, wherein the wrapping layer is formed of a material selected from polymer film, polyethylene, polyolefin, PVC PLA and polypropylene.

10. The insulated apparatus of claim 1, wherein the insulated container comprises a plurality of rectangular prism panels, a first panel forming the base and two pairs of opposed panels forming the upstanding walls of the insulated container.

11. The insulated apparatus of claim 10, wherein at least one of the plurality of panels is enclosed in a wrapping layer, the coefficient of friction of an outer surface of the wrapping layer being greater than the coefficient of friction of an outer surface of the at least one panel.

12. The insulated apparatus of claim 1, wherein the insulated container comprises a molded container.

13. The insulated apparatus of claim 1, wherein the insulated container further comprises a removable lid for selectively sealing an opening defined by the upstanding walls.

14. The insulated apparatus of claim 13, wherein when the removable lid seals the opening defined by the upstanding walls, an inner surface of the removable lid contacts a flap of the inner lining.

15. A process for forming a storage apparatus, the process comprising:
inserting an inner insulated container formed of a first insulating material within an inner chamber defined by an outer container, the inner insulated container having outer dimensions substantially corresponding to interior dimensions of the outer container, the inner insulated container further defining an inner chamber; and
inserting an inner lining formed of a second insulating material within the inner chamber defined by the inner insulated container, the inner lining defining a payload camber.

16. The process of claim 15, further comprising:
forming a first panel and a second panel from the second insulating material according to an interior dimension of the inner insulated container;
placing the first panel to the insulated container to cover two opposite upstanding wall panels and a third of the wall panels contacting the two opposite upstanding wall panels; and
placing a portion of the second panel to the base panel and a fourth wall panel opposing the third wall panel, a remainder of the second panel forming a flap for sealing the opening defined by the wall panels, the adhered first and second panels forming the inner lining.

17. The process of claim 16, wherein placing the first panel comprises one of adhering the first panel and press-fitting the first panel and wherein placing the portion of the second panel comprises one of adhering the portion of the second panel and press-fitting the portion of the second panel.

18. The process of claim 15, wherein inserting the inner lining within the inner chamber is selectively carried out according to a predetermined weight requirement of the storage apparatus, wherein if the predetermined weight requirement is below a predetermined threshold, inserting of the inner lining within the inner chamber is carried out.

19. The process of claim 15, wherein inserting the inner lining within the inner chamber is selectively carried out according to a predetermined temperature retention duration requirement, wherein if the temperature retention duration requirement exceeds a predetermined first duration threshold, the inserting of the inner lining within the inner chamber is carried out.

20. The process claim further comprising:
selecting the second insulating material according to the predetermined temperature retention duration requirement,
if the predetermined temperature retention duration requirement exceeds the predetermined first duration threshold and is less than a second duration threshold, selecting a first category of insulating material as the second insulating material; and
if the predetermined temperature retention duration requirement exceeds the second duration threshold, selecting a second category of insulating material as the second insulating material;
wherein the temperature retention property of the insulating material in the second category is greater than the temperature retention property of the insulating material in the first category.

21. The process of claim 20, further comprising selecting a thickness of the inner lining according to the predetermined temperature retention duration requirement.

22. The process of claim 20, further comprising:
selecting a material for forming the outer container and selecting the first insulating material according to a predetermined durability requirement.

23. The process of claim 22, wherein selecting the first insulating material comprises:
if the predetermined durability requirement indicates reusability of the storage apparatus, selecting polyurethane foam or vacuum-sealed panels as the first material; and
if the predetermined durability requirement indicates disposability of the storage apparatus, selecting polystyrene foam or cardboard as the first material.
